(19) United States
(12) Patent Application Publication
(10) Pub. No.: US 2015/0289485 A1
(43) Pub. Date: Oct. 15, 2015

(54) ALARM DOG COLLAR

(71) Applicant: Jason HORGAN, Davie, FL (US)

(72) Inventor: James Horgan, Davie, FL (US)

(21) Appl. No.: 14/415,682

(22) PCT Filed: Jul. 18, 2013
(86) PCT No.: PCT/US13/51120

§ 371 Date: Jan. 19, 2015

Related U.S. Application Data
(60) Provisional application No. 61/672,955, filed on Jul. 18, 2012.

(51) Int. Cl. A01K 27/00

(52) U.S. Cl. CPC A01K 27/009; A01K 27/006

(57) ABSTRACT

An electronic collar attachment attachable to a dog's collar which allows a user to directly enter, store and view pertinent information relating to, among other things, the dog's identity, medical history, and upcoming appointments and medications, as well as scheduled meal times, medications, and walks. The collar attachment also selectively provides audible, visual, and/or vibration notifications of such upcoming events. The electronic collar attachment includes a rigid and waterproof casing which houses its key components of a display interface, input interface, a speaker, and solid state memory. Data is entered into the electronic collar attachment through its input interface or through a computer via a USB connection. This data is displayed using the electronic collar attachment's display interface.

### CROSS REFERENCE TO RELATED APPLICATIONS

This application claims the benefit of co-pending U.S. provisional patent application Ser. No. 61/672,955 filed Jul. 18, 2012.

### BACKGROUND OF THE INVENTION

1. Field of the Invention

This invention relates generally to an animal collar accessory and, more specifically, to a programmable alarm device which can be removably attached to a dog collar.

2. Description of the Prior Art

Properly caring for a pet requires more than simply providing food, water and bathroom accommodations. On the most basic level, pet care requires maintaining custody and/or keeping track of the location of one's pet. Moreover, pet care, particularly as it relates to dogs, will also typically require periodic visitation to veterinary offices, adherence to a vaccination schedule, and administration of pest and parasite prevention and treatment formulas. Though pet ownership in itself is sufficiently rewarding so as to not cause such reoccurring obligations to discourage many from owning pets, it is unmistakable that when the obligations incident to pet ownership are added to the already busy schedules of pet owners, many find it these obligations difficult to track and remember.

It is well known that dogs kept as pets typically wear collars all or most of the time. This collar is usually the only thing the dog will wears with such frequency. Therefore, if one were seeking to track and be alerted to certain reoccurring obligations as it related to the dog, it would be desirable to utilize the collar to attach the reminder(s) to the dog. U.S. Pat. No. 6,283,065 issued Sep. 4, 2001 entitled “Animal Collar and Stud Assembly that Promotes Animal Safety and Well-Being,” discloses a collar stud which attaches to the collars, wherein the studs can function as tags, collar locks, and/or electronic identification devices. A constraint on existing attachments for dog collars which provide information relating to the dog is that they typically lack an accompanying user interface, lack a display, and are not programmable to provide visual and/or audible alerts.

The Applicant's invention described herein an electronic collar attachment attachable to a dog's collar allows a user to directly enter, store and view pet related information as well as to directly input reminders (such as vaccination dates, medications etc.) into the device and be subsequently notified of such reminders. The electronic collar attachment includes a rigid and waterproof casing which houses and protects its key components of a display interface, input interface, a speaker, and solid state memory. The electronic collar attachment can be programmed using its input interface with information such as the date and time, the dog's name, the contact information for the dog's owner, the dog's veterinarian, the dog's medications, the dog's vaccines, the dog's microchip number, and upcoming or past appointments. The electronic collar attachment can also display this information on its display interface.

### SUMMARY OF THE INVENTION

An electronic collar attachment for attaching to a dog's collar which allows the direct entry, storing, and viewing of pet related information and reminders. The electronic collar attachment comprises a rigid outer casing on which its interface components are located and in which its electronic components are disposed. The interface components include a display interface, input interface, and a speaker. The electronic components include a controller, non-volatile memory, and a power source. Data is entered into the electronic collar attachment through its input interface or through a computer via a USB connection. Information concerning the same can be then conveyed using the electronic collar attachment's display interface or speakers.

The collar attachment utilizes the electronic components to control its internal operations and the operation of its interface components. Several applications are stored in the memory and provide the instructions to the controller to operate the electronic and interface components of the electronic collar attachment. For example, a system application provides instructions for the controller's handling of the interaction between the electronic components and the interface components as well as between interface components. A display application provides instructions to the controller for converting the information (being entered or previously stored) sought to be displayed on the display interface to a format which can be viewed intelligibly over the collar attachment's specific five screen display interface. Additionally, a menu application provides instructions to the controller for organizing the data received or stored and other applications on the device so as to provide intuitive navigation and programming for a user and proper interfacing between the applications and the data. The menu application thus provides the general navigation logic and a search routine. Components of the menu application include a me application and a calendar application.

It is an object of this invention to provide a device that is attachable to a dog's collar which can be used to directly enter certain information that can be stored and retrieved at a later point in time.

It is another object of this invention to provide such an attachable device which can directly display stored information on its face.

It is yet another object of this invention to provide such an attachable device which can provide visual or audible alerts to a user at a preset time or on a preset day.

And yet another object of this invention is to provide such an attachable device which is waterproof.

These and other objects will be apparent to one of skill in the art.

### BRIEF DESCRIPTION OF THE DRAWINGS

FIG. 1 is a top elevational view of the front side of an electronic collar attachment built in accordance with the preferred embodiment of the present invention.

FIG. 2 is a top elevational view of the back side of an electronic collar attachment built in accordance with the preferred embodiment of the present invention.

FIG. 3 is a top elevational view of the back side of an electronic collar attachment built in accordance with the preferred embodiment of the present invention with its USB interface cover removed.

### DETAILED DESCRIPTION OF THE INVENTION

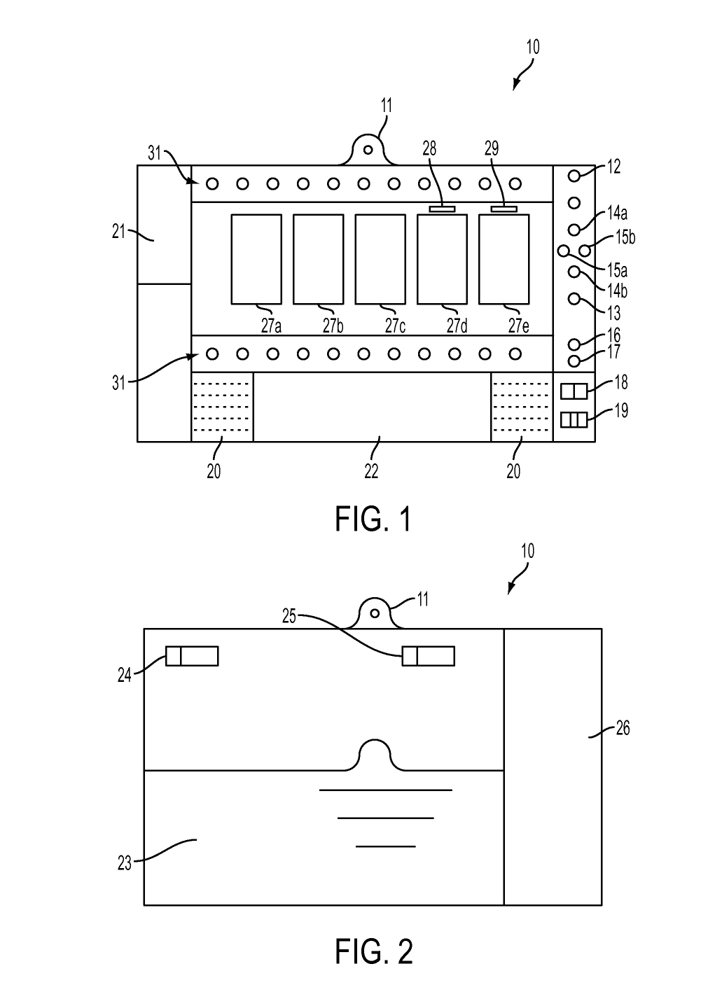

Referring now to the drawings and in particular FIGS. 1 and 2, the outer casing of an electronic collar attachment 10 for attaching to a dog's collar is shown from the front side and the back side. The casing of the electronic collar attachment 10 includes a ring attachment 11 structural component for physically attaching the electronic collar attachment 10 to a dog's collar, as well as interface components such as a display interface and an input interface. In this manner, the casing of the electronic collar attachment 10 provides a housing means for attaching to the collar or harness of a dog. The display interface, which provides a display means disposed on said housing means for displaying information and alerts, includes five discrete display screens 27 (shown as 27a, 27b, 27c, 27d, and 27e), which allow messages and other information to be viewable by a user. In addition, the display interface includes a plurality of light bulbs 31 a located on the face of the collar attachment to provide for additional visual stimuli in the preferred embodiment. The input interface, in providing an input means disposed on said housing means for entering information and commands, includes the following components:

a menu button 12, as a navigational button, for navigating the collar attachment's display interface to its main menu;

an enter (or set) button 13, as a command button, for indicating completion of the a current display interface frame so that the next frame can be navigated to;

two vertical scrolling (or up/down) buttons 14 (shown as 14a and 14b), as navigational buttons, which allow a user to scroll up and down through different screen choice options and keys on the display interface;

two horizontal scrolling (or reverse/forward) buttons 15 (shown as 15a and 15b), as navigational buttons, which allow a use to move between the discrete display screens 27 which comprise the display interface;

a back button 16, as a navigational button, which allows a user to go to the frame or five characters displayed which immediately preceded the present frame or five characters;

an alarm button 17, as a navigational button, for navigating the display interface to the alarm application (or alarm setting routine);

a display toggle switch 18, as a configuration button, for controlling whether the display screens 27 operate with a normal backlight or a neon backlight;

a sound toggle switch 19, as a configuration button, for selecting between an audible tone alarm, a vibration alarm, and a silent alarm;

an alarm signal button 28, as a configuration button, for selecting the type and volume of any tone alarm which is operational; and

an AM/PM toggle switch (or flag) 29, as a configuration button, for switching between military and civilian timekeeping and for allowing am/pm to be set when civilian timekeeping is used.

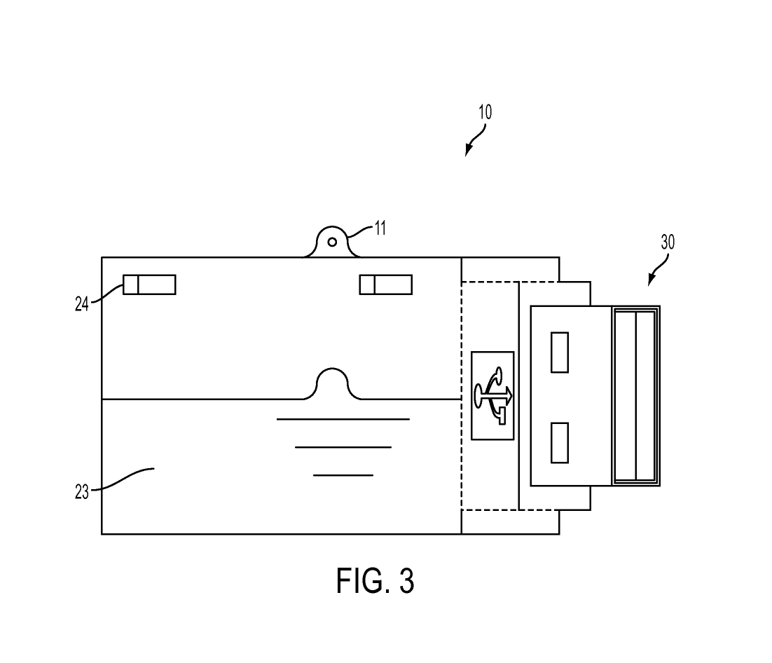

In addition, the collar attachment 10 includes two speakers 20, an area for a vendor or other entity logo 21, and area for a unique unit number 22, a battery compartment 23, a power toggle switch 24, a light switch 25, and a USB interface cover 26. The speakers 20 provide an audio output means for disposed on said housing means for indicating conditions. It is contemplated that the USB interface cover 26 and the cover the battery compartment 23, when both are engaged with the collar attachment 10, form a sufficiently bond to allow the collar attachment 10 to be water resistant Referring now to FIG. 3, when the USB interface cover 26 is removed, a USB port 30 is accessible to allow the collar attachment to be connected to a computer or other USB ready device. The USB port provides an interface means for connecting said collar attachment 10 to an external electronic device.

Inside the collar attachment 10, electronic components including a controller, non-volatile memory, and a power source operate to control the device's operations. Together, the controller, non-volatile memory, and power source provide an electronic control means disposed in said housing means for operating the display means and the input means. In the preferred embodiment, the power source utilized is a battery. A system application provides instructions for the controller's handling of the interaction between the electronic components and the interface components as well as between interface components.

Information is entered into the device using the vertical scrolling buttons, horizontal scrolling buttons, and the enter button. The function of these buttons is controlled by the system application so as to coordinate the interaction between the processor, memory, power, input interface, and the display interface. One feature available due to these components is that users can program custom messages to be alerted and/or displayed at a later point. For example, one owner or caregiver who may have already fed the dog but is leaving the location where the dog is kept can program and cause to be displayed a custom message indicating such (i.e. “Good morning, I already ate breakfast and was walked”).

In the preferred embodiment, five LED screens are utilized. In an alternate, low power embodiment, BCD screens may be used for one or more of the five screens. A display application provides instructions to the controller for taking information being entered or previously stored and formatting it so that it is understandable over the collar attachment's specific five screen display interface. In this manner, the display application applies specific rules concerning the handling of such information. For example, information is provided on the screen with each screen working in concert and displaying no more than one character at any given time. The five screens together, collectively referred to as a frame, can operate sequentially to display messages which require more than five characters. The display of information can be either a display of up to five characters at a time for three seconds or the scrolling display of characters across each screen sequentially (again, a frame being the display of all five screens at a given point of time). The collar attachment automatically separates words or phrases which require more than five characters, including spaces between words, and displays them sequentially over multiple frames. For example, in the 3 second display mode, the phrase “dog to groomer” would be spread over several frames (separated by semicolons) as follows: -D-O-G-_-_-; -T-O-_-_-_-; -G-R-O-O-M-; -E-R-_-_-_-. In this case, each frame would display for three seconds before the next frame was shown and such would repeat until enter is pressed. When messages concerning events are auto scrolled in a calendar function of the collar attachment, a blank frame in inserted between each messages.

As with operating systems generally, many of the system application's operations have significant intersection with the operation of the other applications. For example, as the display application controls scrolling displays, the enter button, who operation is controlled by the system application, is used to finish with a current frame and advance to the next. In situations where enter is pressed while on a frame that has no frames to advance to, however, it causes the display application to move the display interface back to the main display. Similarly, while such scrolling is ongoing, pressing either vertical scrolling button causes the character scrolling to pause and freeze at whatever frame was active when the button was pressed. Subsequent presses of vertical scrolling button causes the characters to scroll at the user's discretion.

A menu application provides the general navigation logic and a search routine. The menu application's instructions allow the controller to organize the data received or stored and other applications on the device so as to provide intuitive navigation and programming for a user and proper interfacing between the applications and the data. Components of the menu application include a me application and a calendar application.

In operation, when an alarm is triggered, the collar attachment utilizes is audible notification function in the form of a tone over its speakers or its vibration notification function along with causing its light bulbs to flash to alert a user visually. The user can then use the vertical scrolling buttons, horizontal scrolling buttons, and the enter button to select a sleep mode or general display mode from the alarm application.

The menu display of the collar attachment allows the user to navigate to time, date, me, calendar, and application settings. As with the previous navigation, the vertical scrolling buttons, horizontal scrolling buttons, and the enter button are used to navigate to and through these screens and/or frames. Notably, the me application allows a user to save information concerning the pet's name, owner (including contact information), veterinarian, vaccine status, chip number and unit number. Similarly, the calendar application provides for the display of a present date and upcoming appointments as well as the entry of appointments, setting of reminders, and the searching of appointments already entered.

It is contemplated that the USB port 30 allows for the direct entry of information and data from an external electronic device, such as a computer or other USB compatible device. Typically, the collar attachment would be plugged into USB and allow the user to enter scheduling and other information on the collar attachment (through XML or file uploads or through text entry) and display all the information from the collar attachment, including alerts. Such information and data includes medical records and digital diagnostics and it is desirable for such to be entered (and subsequently accessible) at a treating veterinarian office. In an alternate embodiment, the collar attachment will also be able to receive and store electrical power from an active USB connection.

In an alternate embodiment, a proximity sensor is included within the collar attachment. The proximity sensor can work in conjunction with a separate proximity base to cause the alarm application in the collar attachment to activate anytime the collar moved further than a predetermined distance from the proximity base. In the alternative (or in addition), the proximity sensor may also include a transponder which can utilize existing GPS systems to allow for the collar's location to be tracked.

In another embodiment, the information stored on the collar attachment can be uploaded to a website and stored in a cloud setting by the respective collar attachment's unique unit number.

In yet another embodiment, the collar attachment is configured to be able to connect to a computer or other computing device (i.e. smart phone) wirelessly. In such an embodiment, an app would be availed to users which would allow the user to pair and connect the collar attachment to the computer or other computing device wirelessly and allow the user to enter scheduling and other information on the collar attachment and display all the information from the collar attachment, including alerts, on any medium, including the collar attachment, computer, smart phone, or a web site.

In still another embodiment, the collar attachment is configured to be attachable anywhere on the dog, such as other dog wear (i.e. harnesses, backpacks).

The instant invention has been shown and described herein in what is considered to be the most practical and preferred embodiments. It is recognized, however, that variations and departures may be made therefrom within the scope of the inventions and that obvious modifications will occur to a person of ordinary skill in the art.

What is claimed is:

1. An electronic collar attachment for attaching to a dog's collar, comprising:
a rigid casing having a front side, a back side, an audio output interface defined by at least one speaker, and an attachment structure, wherein said attachment structure is adapted to be removably attached to the collar or harness of a dog;
a controller connected to a power source and non-volatile memory, wherein said controller, power source, and non-volatile memory are disposed inside said casing and said controller is connected to said audio output interface;
a display interface defined by a plurality of discrete flat panel display screens and a plurality of discrete lighting elements, each disposed on the front side of said rigid housing, wherein said display interface is connected to said controller and said display screens are each configured to display only one character at any given moment;
an input interface defined by a plurality of manual actuators disposed on the front side of said rigid housing, wherein said input interface is connected to said controller; and
wherein said audio output is disposed on the front side of said rigid housing and said controller is configured to cause the storing of data entered via the user interface on said memory, cause the displaying of data in said memory or entered via the user interface on said display interface, and cause the audio output interface and display interface to activate at a predetermined moment.

2. The electronic collar attachment for attaching to a dog's collar of claim 1, wherein said audio output interface includes two speakers.

3. (canceled)

4. The electronic collar attachment for attaching to a dog's collar of claim 1, wherein said power source is defined by a battery.

5. (canceled)

6. The electronic collar attachment for attaching to a dog's collar of claim 5, wherein said display interface includes five flat panel display screens defined as a frame.

7. (canceled)

8. The electronic collar attachment for attaching to a dog's collar of claim 6, wherein the controller is configured to cause the display of words or phrases which require more than five characters to be displayed over a plurality of frames sequentially by way of a display application containing instructions.

9. The electronic collar attachment for attaching to a dog's collar of claim 8, wherein said display application is stored on said memory.

10. The electronic collar attachment for attaching to a dog's collar of claim 1, additionally including a vibration element connected to said controller and disposed in said casing, wherein said controller is configured to cause the vibration element to activate at a predetermined moment.

11. The electronic collar attachment for attaching to a dog's collar of claim 1, wherein said plurality of lighting elements disposed on the front side of said rigid housing are defined as flashing light bulbs.

12. The electronic collar attachment for attaching to a dog's collar of claim 1, wherein said input interface includes at least one navigational button, at least one command button, and at least one configuration button.

13. The electronic collar attachment for attaching to a dog's collar of claim 12, wherein said input interface includes four navigational buttons so as to provide for directional control of the display interface.

14. The electronic collar attachment for attaching to a dog's collar of claim 1, additionally including a computer interface adapted to allow the collar attachment to connect to an external electronic device, wherein said computer interface is connected to said controller.

15. The electronic collar attachment for attaching to a dog's collar of claim 14, wherein said computer interface is defined as a serial interface.

16. The electronic collar attachment for attaching to a dog's collar of claim 15, wherein said computer interface is defined as a USB port.

17. An electronic collar attachment for attaching to a dog's collar, comprising:
a housing means for attaching to the collar or harness of a dog;
an audio output means for disposed on said housing means for indicating conditions;
a display means disposed on said housing means for displaying information and alerts;
an input means disposed on said housing means for entering information and commands; and
an electronic control means disposed in said housing means for operating the display means and the input means.

18. The electronic collar attachment for attaching to a dog's collar of claim 17, additionally including an interface means for connecting to an external electronic device.

19. The electronic collar attachment for attaching to a dog's collar of claim 17, wherein said electronic control means configured to cause the display of words or phrases which require more than five characters on said display means on a series of frames.

20. The electronic collar attachment for attaching to a dog's collar of claim 17, wherein said housing means provides a waterproof casing for said electronic collar attachment.

21. An electronic collar attachment for attaching to a dog's collar, comprising:
a rigid casing having a front side, a back side, an audio output interface defined by at least two discrete speakers, and an attachment structure, wherein said attachment structure is adapted to be removably attached to the collar or harness of a dog;
a controller connected to a power source and non-volatile memory, wherein said controller, power source, and non-volatile memory are disposed inside said casing and said controller is connected to said audio output interface;
a display interface defined by five discrete flat panel display screens and a plurality of discrete lighting elements, each disposed on the front side of said rigid housing, wherein said display interface is connected to said controller, said display screens are each configured to display only one character at any given moment and are collectively defined as a frame, and said lighting elements are each defined as flashing light bulbs;
an input interface defined by a includes a plurality of navigational buttons, at least one command button, and at least one configuration button disposed on the front side of said rigid housing, wherein said input interface is connected to said controller;
a vibration element connected to said controller and disposed in said casing, wherein said controller is configured to cause the vibration element to activate at a predetermined moment;
wherein said audio output is disposed on the front side of said rigid housing and said controller is configured to cause the storing of data entered via the user interface on said memory, cause the displaying of data in said memory or entered via the user interface on said display interface, and cause the audio output interface and display interface to activate at a predetermined moment; and
wherein the controller is configured to cause the display of words or phrases which require more than five characters to be displayed over a plurality of frames sequentially by way of a display application containing instructions.
